(19) United States
(12) Patent Application Publication
(10) Pub. No.: US 2021/0276885 A1
(43) Pub. Date: Sep. 9, 2021

(54) Inflatable boat desalination system based on inflatable non-imaging solar concertrator

(71) Applicant: Yonghua Wang, Klamath Falls, OR (US)

(72) Inventor: Yonghua Wang, Klamath Falls, OR (US)

(21) Appl. No.: 16/873,279

(22) Filed: Mar. 9, 2020

(51) Int. Cl. C02F 1/14; B01D 3/00

(52) U.S. Cl. CPC C02F 1/14; C02F 2103/08; B01D 3/007

(57) ABSTRACT

A portable floating sea water desalination system is presented to realize ultra-high efficiency and extremely low cost water purification. The disclosed system comprises an inflatable non-imaging solar concentrator based compact desalinator subsystem, a photovoltaic powered distillation subsystem, and an inflatable rubber boat system. The inflatable non-imaging solar concentrator concentrates both beam light and diffuse light into an envelope type evaporator to evaporate the brine water to realize extremely low cost. A nano materials absorber is incorporated into the evaporator to realize ultra-high efficiency. A portion of the heated brine water contained in the evaporator is circulated to the photovoltaic powered distillation subsystem for further evaporation. Both of the subsystems above are mounted on the inflatable rubber boat subsystem for portability.

### TECHNICAL FIELD

The present disclosure relates generally to water desalination, more specifically, to inflatable boat desalination system based on inflatable non-imaging solar concentrator.

### BACKGROUND

Even though, 70% of earth is covered with ocean and is full of water, many regions of the planet are lack of water. Some coastal areas, islands, harbor cities surrounded by plenty of water are troubled with water scarcity. Many desserts in Middle East countries such as Saudi Arab, Iran, Oman, and AEU located in the coastal areas are extremely lack of fresh water. The more sea water, the less fresh water. Therefore, desalination is increasingly being considered as an important potential solution to increase water supplies for municipal water and agriculture, and is an essential technology to purify water produced from various industrial processes, as well as from oil and gas exploration. Each market presents different possible avenues to integrate solar thermal energy into the process as the primary energy resource. Most municipal desalination in the world utilizes reverse osmosis (RO), which is performed at ambient temperatures with no special heating of the feed stream. However, low-cost solar thermal energy can potentially make thermal desalination a low cost option, while reducing demand for electricity, the primary energy input into RO processes. Agriculture has high water demands with runoff that is typically saline due to salts in the soil and groundwater occurring naturally high salt content and is often generated away from grid infrastructure. Thermal desalination, in general, has particular application for water with high total dissolved salt (TDS) content or for applications that require zero liquid discharge (ZLD), which RO cannot typically address.

One of the solar desalinations is called solar distillation (John A. Duffie and William A. Beckman, Solar Engineering of Thermal Processes, 4^{th} Edition, PP 640-647). This still utilizes a shallow black basin to hold the salt water and absorb solar radiation; water vaporize from the brine, condense on the underside of a sloped transparent cover, run into troughs, and is collected in tanks at the end of the still. The advantage of the still is that the incident solar radiation is directly absorbed to evaporate the water. The drawback of this still is that the vapor condensed on the underside of the transparent cover reduces the transparency of the cover, and consequently, reduces the efficiency of the still. The other drawbacks of the still are that the basin occupies large area of land and the large area bottom of the basin needs to be insulated.

Another solar desalination is concentrating solar distillation. In this still, the concentrating solar thermal technologies are used to convert the solar flux into heat, and then transferred to a heat exchanger to evaporate the water from brine. Although this approach overcomes the drawbacks of the shallow black basin based green-house type still described above, the conventional collecting elements the concentrators are costly and the system is complicated.

No matter what type of solar desalination system is adopted, any of the system will inevitably occupy immense land area to collect solar radiation. In most of the cases, there are no such areas of land available to support water supply to large cities, islands, or ships.

The goal of this application is to provide: (1) a design paradigm of concentrating solar desalination system that directly concentrate solar flux and deliver it to a receiver merged in the sea water contained in an evaporator which circulates the sea water to another distillation system to significantly raise efficiency, and dramatically reduce the cost of concentrating system by employing my newly invented “Inflatable Non-imaging Solar Concentrator” (INSC); (2) a solution to address the issue of missing land areas for solar collector fields by mounting the entire solar desalination systems on inflatable boats floating on sea water to avoid occupying land areas. The close structure INSC made of thin and light materials is not only able to extraordinarily reduce the cost of the concentrator itself, but also able to get rid of any support and fasten parts with a gas expanded membrane apparatus. The INSC can concentrate not only beam light, but also diffuse light with high concentration ratio up to more than 100 suns. The INSC is combined with an envelope type evaporator to form a compact desalination system, which has a circulation system connected to a photovoltaic system powered distillation system to enhance evaporation and condensation.

The desalination system disclosed in this application consists of: an inflatable boat array subsystem floating on surface of sea as the platform for the solar collector field; an inflatable non-imaging solar concentrator based compact desalinator with envelop type evaporator array subsystem; and a photovoltaic powered distillation subsystem. Where, the inflatable non-imaging solar concentrator based compact desalinator is constructed by positioning the INSC into an envelope type evaporator with a nano materials absorber block and a circulation system. When in operation, the following steps happen: (1) the incident sunlight is concentrated to the absorption coating or block made of porous materials through the INSC to evaporate the water; (2) the generated steam from the receiver rise in the house of the envelope and arrive at the condenser; (3) the condensed water is collected by the collector. In order to enhance the evaporation and condensation process, the heated sea water contained in the envelop type evaporator of the compact desalinator described above is circulated to another photovoltaic powered distillation system simultaneously for further evaporation and condensation. Consequently, a multiple effect system is constructed to raise overall efficiency of the entire system.

### OBJECTS AND ADVANTAGES

In this disclosure, the INSC, which is super-light, ultra-low cost, and extremely simple, is employed to directly concentrate the incident sunlight to the absorber located at the basin of the evaporator which is attached to the INSC, so that the intermediate processes happen in other concentrating solar thermal systems are completely avoided and the heating efficiency is dramatically raised. Since the INSC is a gas expanded self-supporting structure, there is no need for other support structure. The envelop type evaporator is simply an attachment to INSC. This makes the whole desalination system a compact and portable system. INSC is separated with the evaporator house and merged into the brine water, so the generated vapor of water will not condense on the output aperture of the concentrator and there is no transparency loss on the concentrator. By using INSC, the bottom area of the envelop type evaporator is dramatically reduced, and this enables a much better insulation structure of the evaporator.

In order to synergistically combine the advantages of direct evaporation process and the separated collection and evaporation process, the present invention incorporate an additional solar photovoltaic powered distillation subsystem into the system. The heated sea water contained in the evaporator of the compact desalinator is simultaneously circulated out to a distillation system powered by solar photovoltaic system for further evaporation, so that the multiple effect evaporation effected to enhance the evaporation and condensation. Furthermore, the introduction of the photovoltaic system with electric storage balances the fluctuation of solar radiation and ensures the constant water production.

The entire array of the compact desalinators and the auxiliary solar powered distillation system are mounted on a floating inflatable boat system to avoid occupying the useful lands and make it a portable system.

### SUMMARY

In summary, this invention provides an ultra-high efficiency and extremely low-cost solar desalination system. Based on the Inflatable Non-imaging Solar Concentrator (INSC), this system is extremely cheap in the sense that cheap thin materials and thin coating films are used to form a gas expanded structure without support parts. The concentrator directly concentrates the incident sunlight including beam light and diffuse light onto the absorber merged in the brine water of evaporator, so that the heating efficiency is dramatically enhanced. The entire desalination system is formed by attaching an envelope type evaporator to the INSC and the sunlight collecting space and the water evaporation space are separated in the system. The bottom area of the desalinator is dramatically shrunken to facilitate the insulation and the evaporation operation.

The brine water contained in the envelope type evaporator and heated by the concentrated sunlight guided from the INSC is circulated to another photovoltaic powered distillation subsystem simultaneously when it is vaporizing in the chamber of the evaporator, so as to enhance the evaporation and condensation and realize the effective control of the performance of the entire desalination system under the varying solar radiation.

The entire desalination system is mounted on an Inflatable Boat Array system to avoid occupying the useful lands and make the system portable.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 is the overview of the assembly of the inflatable non-imaging solar concentrator based compact desalinator. It is a combination of an inflatable non-imaging solar concentrator and a envelope type evaporator with the heated sea water circulation pipes.

FIG. 2 is the cross section view of the assembly of the inflatable non-imaging solar concentrator based desalinator. Where, the close structure of the solar concentrator, the structure of the evaporator, the nano materials absorber, the circulation pipes, the house formed by inner and outer holders, and the combined condenser and collector, are shown.

FIG. 3 is the cross section view of the dismantled evaporator with the nano materials absorber and the circulation pipes.

FIG. 4 is the demonstration of the work principle of the non-imaging concentrator, which concentrates both of beam light and diffuse light.

FIG. 5 is the assembly of the inflatable non-imaging solar concentrator based desalinator subsystem mounted on a rubber boat.

FIG. 6 is the assembly of the photovoltaic powered distillation subsystem mounted on a rubber boat.

FIG. 7 is the overall system assembly.

FIG. 8 is the schematic configuration of the entire desalination system.

### DETAILED DESCRIPTION

Reference will now be made in detail to the present exemplary embodiment, example of which is illustrated in the accompanying drawings. Wherever possible, the same reference numbers will be used throughout the drawings to refer to the same or like parts.

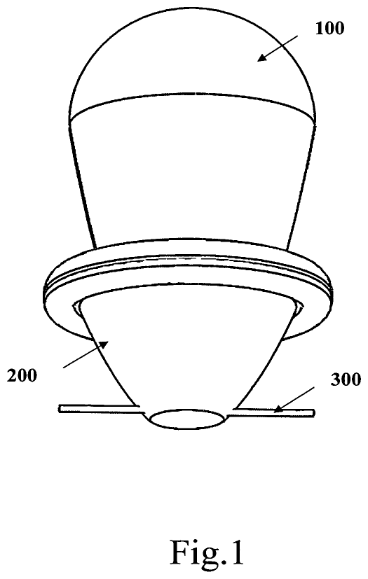

Referring to FIG. 1, the inflatable non-imaging solar concentrator water desalination system comprises three major components: (1) inflatable non-imaging solar concentrator 100, which is a close structure stationary solar concentrator and is able to concentrate both beam light and diffuse light; (2) evaporator 200 as an envelope surrounding the concentrator 100; (3) circulation pipes 300. The bottom of the concentrator 100 is directly sitting on the bottom of the evaporator 200 to concentrate the incident light to the absorber located on the bottom of the evaporator 200. The brine water feeding in evaporator 200 is partially evaporated by the absorber, and the rest part is circulated out to the photovoltaic powered distillation subsystem for further evaporation through the circulation pipes 300.

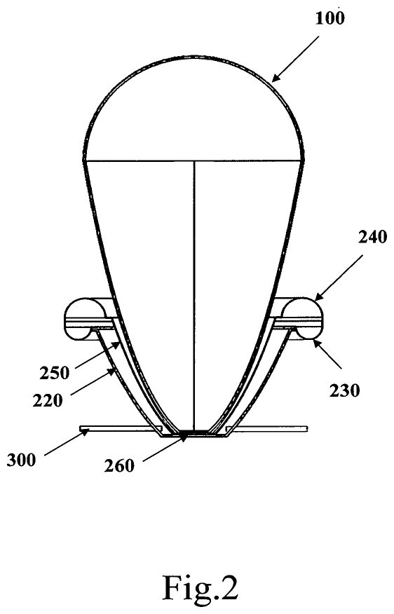

Referring FIG. 2, the evaporator 200 consists of the outer holder 220, the freshwater collector 230, the condenser 240, the inner holder 250, and the absorber 260. The inner holder and outer holder form a house for evaporation. When in operation, the brine water is feed in the bottom of the outer holder 220; the incident sunlight is concentrated to the absorber 260, which is merged into the brine water, to evaporate the water; the vapor generated on the surface of the brine water rise in the house formed by the inner holder 250 and outer holder 220, and arrive at the condenser 240, and get condensed there and collected in the collector 230.

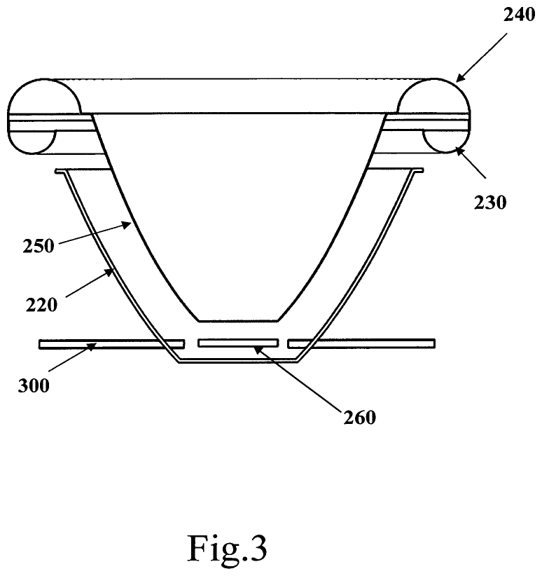

Referring FIG. 3, the nano materials absorber 260 is positioned at the bottom of the outer holder 220, which serves as the container of the brine water.

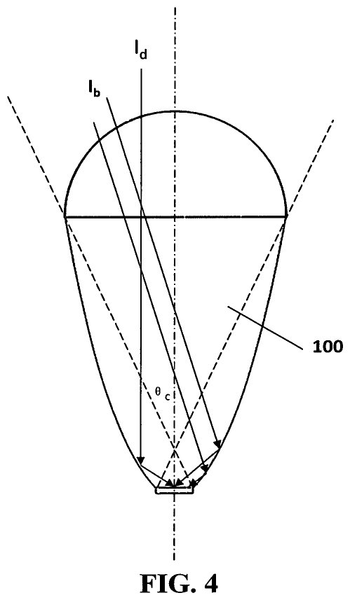

Referring FIG. 4, the inflatable non-imaging concentrator has two portions, the upper transparent cover, and the lower Compound Parabolic Concentrator (CPC). When in operation, both the beam light I_{b} and the diffuse light I_{d} are concentrated onto the bottom of the CPC, as long as they fall into the half acceptance angle θ_{c}.

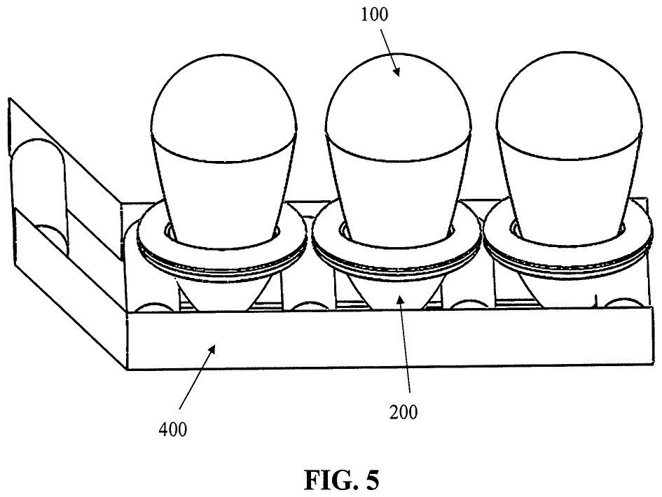

Referring FIG. 5, the inflatable non-imaging solar concentrator based desalinator array is mounted on a rubber boat 400 to form the compact desalinator array subsystem.

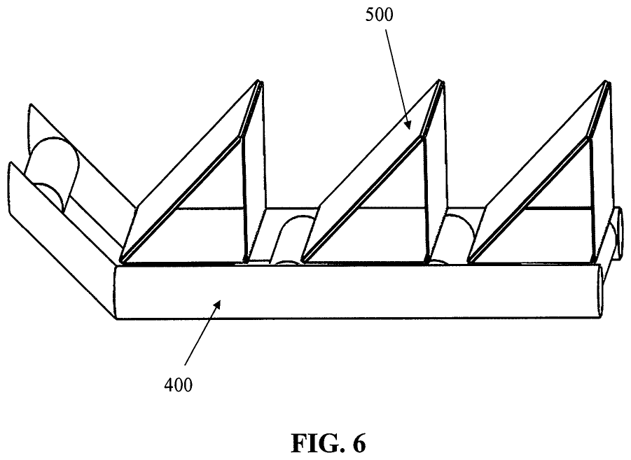

Referring FIG. 6, the photovoltaic panel array 500 is mounted on the rubber boat 400 to form the photovoltaic powered distillation subsystem with electric storage and thermal storage.

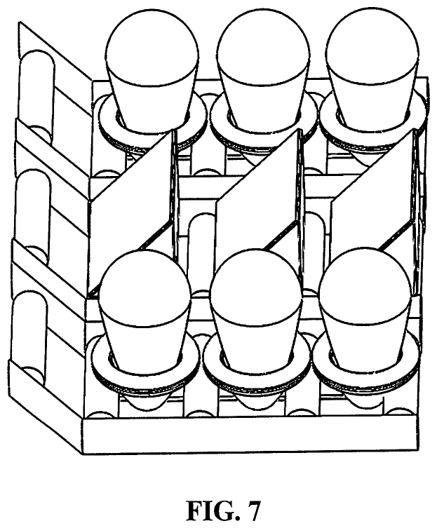

Referring FIG. 7, a few of the desalinator modules and photovoltaic powered distillation system modules are assembled together to form the entire desalination system.

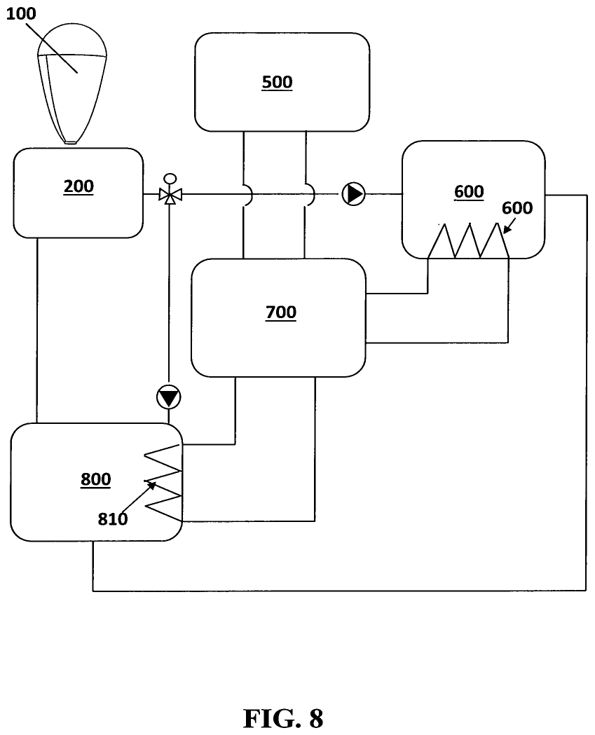

Referring FIG. 8, the entire system consists of: (1) the inflatable non-imaging solar concentrator based compact desalinator subsystem which comprises the concentrator 100 and the evaporator 200; (2) the photovoltaic powered distillation subsystem which comprises the photovoltaic panel array 500, battery storage 700, thermal storage 600 with electric heater 610, and distillation system 800 with the electric heater 810. When in operation, the brine water contained in the evaporator 200 is heated up with the sunlight concentrated by the concentrator 100, a portion of water evaporate directly, and the rest portion of water is pumped to the thermal storage 700 heated by the electric heater 610 powered by the photovoltaic system consists of the photovoltaic panel array 500 and the battery storage 600, or the distillation system 800 with electric heater 810 powered by the photovoltaic system for further evaporation.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. An inflatable non-imaging solar concentrator based water desalination system, comprising:
a. an inflatable non-imaging solar concentrator based compact desalinator subsystem;
b. a photovoltaic powered water distillation subsystem;
c. an inflatable rubber boat subsystem;
wherein, the inflatable non-imaging solar concentrator based compact desalinator subsystem heats up the brine water feed in the subsystem and evaporate a portion of the brine water, then transports the rest of the heated brine water to the photovoltaic powered water distillation subsystem for further evaporation, both of the two subsystems are mounted onto the inflatable rubber boat subsystem to form a portable floating system.

2. The inflatable non-imaging solar concentrator based compact desalinator subsystem of claim 1 consists of an inflatable non-imaging solar concentrator, an envelope type evaporator, and circulation pipes.

3. The envelope type evaporator of claim 2 contains a nano materials absorber.

4. The photovoltaic powered water distillation subsystem consists of a photovoltaic panel array, a battery storage, a thermal storage, and a water distillation system.

5. The thermal storage of claim 4 has an electric heater.

6. The water distillation system of claim 4 has an electric heater.
